(19) United States
(12) Patent Application Publication
(10) Pub. No.: US 2005/0091292 A1
(43) Pub. Date: Apr. 28, 2005

(54) Classificatory accounting calculator structure

(76) Inventor: Jui-Sheng Pai, Nan-Tou Hsien (TW)

Correspondence Address: RABIN & BERDO, P.C.;Suite 500, 1101 14th Street, N.W., Washington, DC, 20005, US

(21) Appl. No.: 10/689,728

(22) Filed: Oct. 22, 2003

(51) Int. Cl. G06F 3/00

(52) U.S. Cl. 708/160

(57) ABSTRACT

A classificatory accounting calculator structure, the calculator consisting of a plurality of classification keys, operation keys, and function keys such that when the operator presses amount number numeric keys, respectively inputting to each classification key, an internal microprocessor and memory storage enables screen display and verification. When the operation keys are operated, searched operative results can be viewed on a screen or under the coordinated operation of the function keys with the classification keys, originally inputted records can be displayed for update and search usage. As such, the operator utilizes the portable calculator to immediately record amounts spent at the moment of transaction, thereby effectively achieving classificatory accounting inputted searches.

### BACKGROUND OF THE INVENTION

1) Field of the Invention

The invention herein relates to personal organizing devices, specifically a classificatory accounting calculator structure utilizing a plurality of classification keys, operation keys, and function keys disposed on the surface of the calculator that provides for the operator directly utilizing the portable calculator to immediately record amounts spent at the moment of transaction and search the expenditures status at any time, which solves the conventional drawbacks of loss, incompleteness, and mistakes when paper and pen are used for recording expenses, thereby effectively achieving complete classificatory accounting.

2) Description of the Prior Art

The overwhelming majority of people or family member in charge of monitoring expenses will often spend cash on hand without full awareness. This is especially the case when monthly salaries are received; since wallets are full, purchases are made as desired. Such spending often continues without limits and by the end of the month, both pockets are discovered to have either little or nothing remaining in them. There is either no idea as to where the money was spent or a dim recollection of that goes no farther than, “It seems that . . . ,” which is not necessarily accurate. Thus, since it is not possible to completely remember exactly how money was spent for a given month, the notion of “keeping account” emerges, where it is only necessary to record expenses until the end of the month when adding them up allows knowing where the money was spent. As such, the keeping account approach definitely provides for an accurate record that does not require mind boggling recall. Although such accounting is a fine approach, the applicant of the invention herein as well as many other people have discovered through observation that some account keeping methods today utilize paper and pen to record spent amounts, wherein when an amount is spent outside, the usual thought occurs to write it down. However, if there is no paper and pen at that moment, it can be recorded upon returning home, at which time keeping account is often forgotten. This is especially so if a person has to handle an errand somewhere else after money is spent. One slip of the mind can result in an inability to recall and having number of accounting entries to remember can be confusing. As a result, if keeping account does not happen in real-time when spending occurs, there will be discrepancies in the results. Additionally, if records are kept on a conveniently available piece of paper at the time of transaction, they must be filed after returning home, a situation wherein the said piece of paper occasionally cannot be found or the figures are incorrectly written and/or illegible, all of which result in major errors when totaling accounts. Even further, to maintain a complete written record of monthly expenditures, since the recorded amounts must also be itemized under the daily life categories of food, clothes, housing, transportation, education, and entertainment, the conventional paper and pen recording approach is incapable of enabling most people to enjoy the convenience of classificatory accounting.

As a result, persons have thought about whether a calculator is capable of keeping records. Based on an understanding of calculators, electronic dictionaries, and other related products now available on the market, although they have telephone number, name, monetary exchange rate or currency conversion, and other recording capabilities, none have the said classificatory accounting functions. Thus, most people will not utilize the said calculators for the purpose of keeping account. Another reason is that the said conventional calculators are incapable of storing inputted numbers in memory; switching off their power erases everything and precludes their use for such applications.

In view of the said situation, the applicant of the invention herein made observations and committed extensive thought based on many years of experience gained while engaged in the said relevant industry that culminated in the successful development of the invention herein.

### SUMMARY OF THE INVENTION

The primary objective of the invention herein is to provide a classificatory accounting calculator structure, the calculator consisting of a plurality of classification keys, operation keys, and function keys such that when the operator presses amount number numeric keys, respectively inputting to each classification key, an internal microprocessor and memory storage enables screen display and verification and, furthermore, through the operation of the event and total operation keys, the searched calculated results are shown on the screen, and also displayed are the records, corrections, and searches inputted by the various function key in coordination with the classification keys, the operation keys, and the function keys; as such, the operator utilizes the portable calculator to immediately record amounts spent at the moment of transaction, which solves the conventional situations of loss, discontinuity, and mistakes when paper and pen are used for recording expenses, thereby effectively achieving classificatory accounting with comprehensive inputting and search performance.

### BRIEF DESCRIPTION OF THE DRAWINGS

FIG. 1-A is an orthographic drawing of the invention herein.

FIG. 1-B is a block diagram of the unit organization of the invention herein.

FIG. 2 is an orthographic drawing of the invention herein that illustrates the calculate operation.

FIG. 3-A is a Drawing (1) of memory input numeral classification of the invention herein.

FIG. 3-B is a Drawing (2) of memory input numeral classification of the invention herein.

FIG. 3-C is a Drawing (3) of memory input numeral classification of the invention herein.

FIG. 3-D is a Drawing (4) of memory input numeral classification of the invention herein.

FIG. 3-E is a Drawing (5) of memory input numeral classification of the invention herein.

FIG. 3-F is a Drawing (6) of memory input numeral classification of the invention herein.

FIG. 3-G is a table of memory input numeral classification by date of the invention herein.

FIG. 4 is an orthographic drawing of the invention herein, showing a classification event calculation.

FIG. 5 is an orthographic drawing of the invention herein illustrating the totaling operation.

FIG. 6 is a table of the classification event and totaling operation.

### DETAILED DESCRIPTION OF THE INVENTION

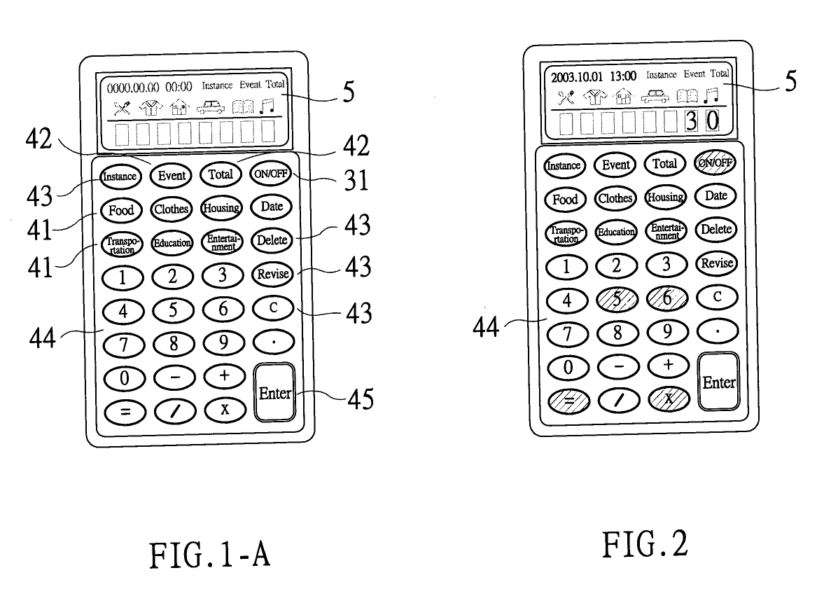

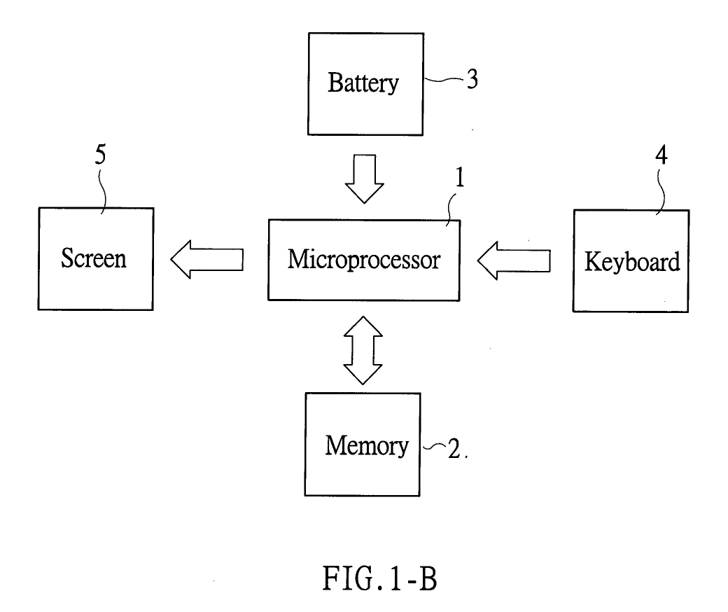

Referring to FIG. 1-A and FIG. 1-B, the classificatory accounting calculator structure of the invention herein is comprised of a microprocessor 1, memory 2 that provides for storage, a battery 3 that provides for electronic operation, a keyboard 4 that provides for inputting, and a screen 5 that provides for displaying results; the said battery 3 is controlled by operating an ON/OFF-labeled switch key 31 and can be modified to a solar energy power arrangement, and the keyboard 4 has a food, a clothes, a housing, a transportation, an education, and an entertainment classification key 41; an event and a total operation key 42; an instance, a date, a revise, and a delete function key 43; numeric keys 44 as originally found on calculators; and an enter key 45 handles the memory storage of the pressed numeric keys 44 and classification keys 41.

As such, when the said calculator switch key 31 is pressed, the current date and time, the event and total operation key 42, the instance function key 43, and the “food”, “clothes”, “housing”, “transportation”, “education” and “entertainment” icons along with the numeral “0” are displayed on the screen 5 (as indicated in FIG. 1-A), at which time if the keyboard 4 is not pressed for a certain period of time, the said calculator automatically switches off to stop unnecessary power consumption. When a monetary amount has not been inputted into the memory of the said calculator, i.e. none of the classification keys 41, the operation keys 42, and the function keys 43 have been pressed, then like conventional calculator operation, the present invention provides for addition, subtraction, multiplication, and division operations (as shown in FIG. 2).

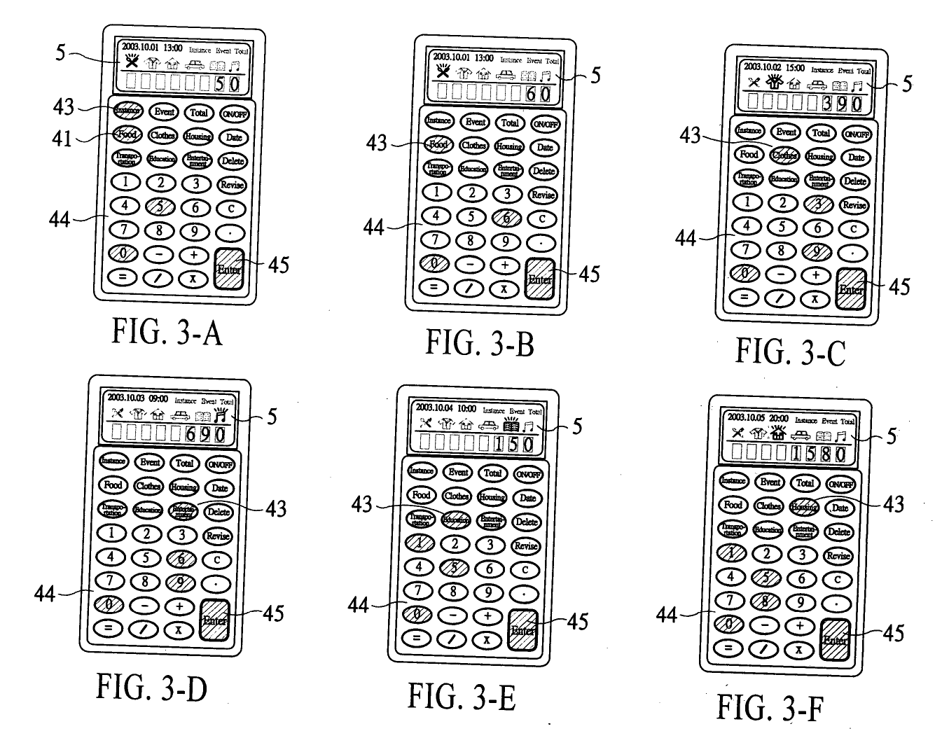

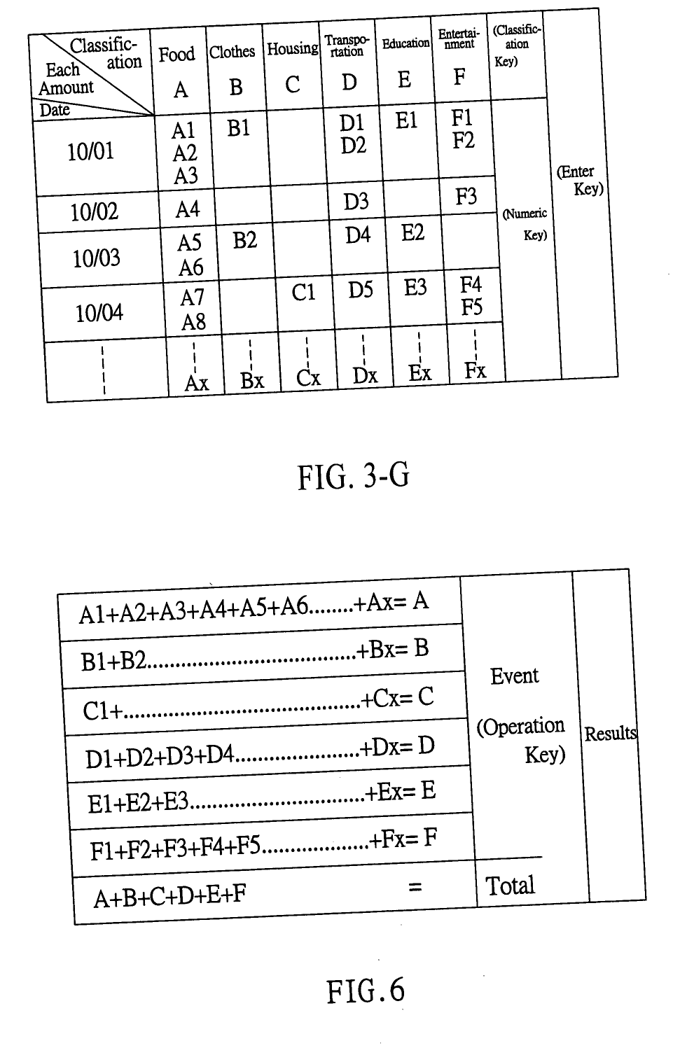

When the operator pays cash for a purchase, the amount is classified as a daily expense under food, clothes, housing, transportation, education, or entertainment, following which the portable said calculator is taken out, turned on to automatically display the current date, the numeric keys 44 for the said amount are pressed, the numerals are shown on the screen 5, one of the classification keys 41 (food, clothes, housing, transportation, education, or entertainment) is pressed, the icon so selected begins to flash on the screen 5 for operator confirmation, the enter key 45 is then pressed, terminating the flashing state of the icon last shown on the screen 5, indicating that the said operation is recorded and stored; as indicated in FIG. 3-A, if the breakfast expense for the current day is TWD50, the “5” and “0” and then the “food” key are pressed, the representations of the said keys start to flash on the screen 5 to provide for confirming correctness, following which the enter key 45 is pressed. If a classification or a numeral error was entered, even though the enter key 45 has already been pressed, the “revise” key among the function keys 43 is capable of deletion and the internal memory 2 does not store the erroneous data, following which the correct data is inputted and the enter key 45 is pressed; later, when there is a second expense of the same category, it is inputted, recorded, and saved under the identical classification, thus, if the lunch expense was TWD60 on the same day, it would be inputted and recorded accordingly (as shown in FIG. 3-B); by the same principle, when an article of apparel is purchased the next day for TWD390, then this amount is included under the “clothes” classification (as shown in FIG. 3-C); similarly, TWD690 is spent on another day for enjoying music and the amount is included under the “entertainment” classification (as shown in FIG. 3-D); TWD150 is used to buy a reference book on another day, the amount included under the “education” classification (as shown in FIG. 3-E); and the landlord collects TWD1,580 in rent which is included under the “housing” classification (as shown in FIG. 3-F); as such, the operator classifies expenditures according to food, clothes, housing, transportation, education, and entertainment, enabling the calculator internal memory 2 to record and store according to the date and the classification (as shown in FIG. 3-G); however, if the “delete” key among the “event” or “total” is pressed, then the designated said event or all the stored data can be deleted, therefore, the internal data cannot be lost after the power supply of the said calculator is switched off. If the memory 2 inside the calculator that provides for recording and storage is full, the number “99999999” is displayed on the screen 5, indicating that no further data can be recorded and stored, at which time the operator should check whether this is the result of said deleted data still occupying memory space, such that after deletion space is transferred, thereby providing for the continued storage of useful data.

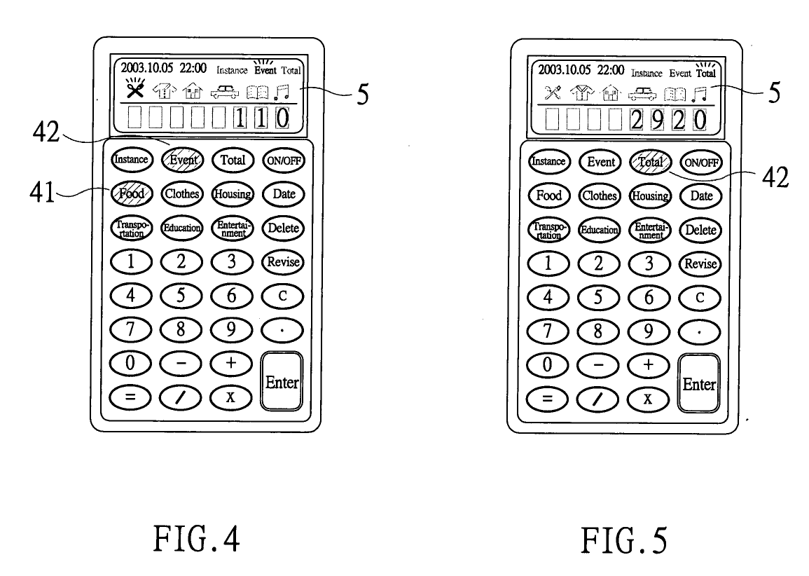

Understanding the current expenses situation a few days later occurs through microprocessor 1 operation (as shown in FIG. 6), wherein the classification key 41 and the operation key 42 are pressed to display the food, clothes, housing, transportation, education, and entertainment statistical results, as indicated in FIG. 4: when the “food” key and the “event” key are pressed (the said representative symbols and event characters appear in a flashing state on the screen 5), the relevant food classification amounts of the current month are added up statistically and the result displayed is “110”; by the same principle, when the “clothes” key an the “event” key are pressed (the said representative symbols and event characters appear in a flashing state on the screen 5), the relevant clothes classification amounts of the current month are added up statistically and the result is displayed; relatively, to understand the amount of total expenditures for a current month, pressing the operation key 42 “total” key (the total appears in a flashing state on the screen 5) displays “2,920”, the total for six events, on the screen 5, as indicated in FIG. 5.

If viewing data for the current month is finished and further storage is unnecessary, using “event” or “total” and then pressing the function key 43 “delete” key eliminates the stored event or data and returns to the zero state, after which the next month's data is inputted and stored to once again record and archive it, thereby preventing the storage of deleted data by the calculator internal memory 2 which would otherwise occupy memory space and disable normal usage.

And it is not only as such, to examine the listed expenditures situation of a certain date during a current month, pressing the function key 43 “date” key once, followed by inputting the date and then selecting one of the food, clothes, transportation, or education classification keys 41 causes the said representative symbols to start appearing in a flashing state on the screen 5, after which selecting the “event” key (event appears in a flashing state on the screen 5), thereby displaying the statistical amount of expenditure on the current day under the said classification; by pressing the “instance” key (instance appears in a flashing state on the screen 5), following which is displayed the amount of the first expense on the current day under the said classification; after the “instance” key is pressed a second time, the amount the second expense on the current day under the said classification is sequentially displayed, with the procedure repeated until the very last instance, when the numeral “0” is displayed; by the same principle, pressing the “total” key (total appears in a flashing state on the screen 5) displays the total expenditures situation of the inputted date. Additionally, if an error is discovered, pressing the “revise” key when the said amount is displayed causes the deletion of the said data and, after replacement with the correct data, the enter key 45 is pressed to place it in memory. By the same principle, if the date is wrong, pressing the function key 43 “date” key three times causes the year, month, day, and time characters to flash, following which the correct characters are inputted.

As such, the plurality of function keys 43 supports each classification key 41 and operation key 42, with simultaneous displays for monitoring input correctness and executing searches.

As such, the operator directly utilizes the portable calculator to immediately record amounts spent at the moment of transaction and place them in classificatory storage, as if it were a portable accounts manager, wherein it is only necessary to know the current spending situation and accordingly press several keys to instantaneously calculate, which solves the conventional situations of loss, incompleteness, and mistakes when paper and pen are used for recording expenses, thereby effectively achieving classificatory accounting with comprehensive inputting and search performance.

At the same time, the classification keys 41 of the invention herein accommodates various industrial and utilization requirements, including modified terminology or increasing key quantity to similarly achieve classificatory statistical and searches functionality.

In summation of the foregoing section, since the invention herein possesses practical utility and meets new patent application requirements, the present invention is submitted to the patent bureau for review and the granting of the commensurate patent rights.

1. A classificatory accounting calculator structure consisting of a numerical input capability calculator, the interior section of which is comprised of a microprocessor, memory, a battery, a keyboard, and a screen; furthermore, a plurality of classification keys, operation keys, and function keys are disposed on the surface of the calculator that provides for inputting, such that the operator presses the number of the current day using the said classification keys and at the same time records and stores, which is then displayed on the said screen and, following verification, through the operation of the said operation keys, the searched calculated results are shown on the said screen, and also displayed are the records, corrections, and searches inputted by the various said function key and in coordination with the said classification keys, the said operation keys, and the said function keys; as such, the operator utilizes the portable calculator to immediately record amounts spent at the moment of transaction, which solves the conventional situations of loss, incompleteness, and mistakes when paper and pen are used for recording expenses, thereby effectively achieving classificatory accounting with comprehensive inputting and search performance.

2. A classificatory accounting calculator structure as claimed in claim 1 in which the said plurality of classification keys disposed on the surface of the calculator that provide for inputting are divided into food, clothes, housing, transportation, education, and entertainment such that after the statistical operation by an event and a total said operation key, the calculated results are displayed on the said screen.

3. A classificatory accounting calculator structure as claimed in claim 1 in which the said plurality of operation keys disposed on the surface of the calculator that provide for inputting are divided into event and total such that in coordination with the operation of the said classification keys, events or instances that are added up are totaled, the operative results of which are then displayed on the said screen.

4. A classificatory accounting calculator structure as claimed in claim 1 in which the said plurality of function keys disposed on the surface of the calculator that provide for inputting are divided into instance, date, revise, and delete such that in coordination with the operation of the said classification keys and the said operation keys the inputted corrections for executing searches and updates are viewable, following which the results are displayed on the said screen.
